(19) United States
(12) Patent Application Publication
(10) Pub. No.: US 2006/0233597 A1
(43) Pub. Date: Oct. 19, 2006

(54) Cam based rod connection system and method

(76) Inventors: Micheal D. Ensign, Salt Lake City, UT (US); David T. Hawkes, Pleasant Grove, UT (US)

Correspondence Address: RADER, FISHMAN & GRAUER PLLC, 10653 SOUTH RIVER FRONT PARKWAY, SUITE 150, SOUTH JORDAN, UT, 84095, US

(21) Appl. No.: 11/406,204

(22) Filed: Apr. 18, 2006

Related U.S. Application Data
(60) Provisional application No. 60/672,590, filed on Apr. 18, 2005.
(60) Provisional application No. 60/703,622, filed on Jul. 29, 2005.
(60) Provisional application No. 60/703,684, filed on Jul. 29, 2005.

(51) Int. Cl. H01J 5/32

(52) U.S. Cl. 403/177

(57) ABSTRACT

In one of many possible embodiments, the present exemplary system provides a connection member for coupling to one or more structural rods including a coupler body defining a first recess sized to receive the structural rod, and a cam mechanism positioned adjacent to the first recess, wherein the cam mechanism is configured to selectively vary a size of the first recess to couple the structural rod in the first recess.

### RELATED APPLICATIONS

This application claims the benefit under 35 U.S.C. § 119(e) of U.S. Provisional Patent Application No. 60/672,590 filed Apr. 18, 2005, titled “Helical Cam Hook,” U.S. Provisional Patent Application No. 60/703,622 filed Jul. 29, 2005, titled “Offset Connector,” and U.S. Provisional Patent Application No. 60/703,684 filed Jul. 29, 2005, titled “Rod to Rod Connector.” The provisional applications are incorporated herein by reference in their entireties.

### TECHNICAL FIELD

The present exemplary system and method relates to medical devices. More particularly, the present exemplary system and method relates to cam based systems and methods for securing an orthopedic rod.

### BACKGROUND

The use of bone stabilization/fixation devices to align or position bones is well established. Furthermore, the use of spinal bone stabilization/fixation devices to align or position specific vertebrae or a region of the spine is well established. Typically such devices for the spine utilize a spinal fixation element, comprised of a relatively rigid member such as a plate, a board, or a rod that is used as a coupler between adjacent vertebrae. Such a spinal fixation element can effect a rigid positioning of adjacent vertebrae when attached to the pedicle portion of the vertebrae using pedicle bone anchorage screws. Once the coupled vertebrae are spatially fixed in position, procedures can be performed, healing can proceed, or spinal fusion may take place.

Spinal fixation elements may be introduced to stabilize the various vertebrae of the spine. Some devices for this purpose are designed to be attached directly to the spine, but the generally invasive nature of standard paraspinal approach used to implant these devices may pose drawbacks. For example, muscle disruption and blood loss may result from standard paraspinal implantation approaches.

While connection of the spinal fixation elements to a spinal element may be performed by any number of couplers such as screws, hooks, and the like, many spinal fixation elements include the use of a stabilization rod. While stabilization rods can provide effective stabilization to a desired area, a number of obstacles are introduced with the use of stabilization rods. Specifically, a number of stabilization rods having varying diameters may be used to stabilize a desired area. Oft times, the rods having varying diameters should be joined to provide a single continuous source of stabilization. However, the varying rod diameters often require large and bulky apparatuses to securely join the members, which may result in more tissue damage in and around the surgical site when the system is installed during surgery.

### SUMMARY

In one of many possible embodiments, the present exemplary system provides a connection member for coupling to one or more structural rods including a coupler body defining a first recess sized to receive the structural rod, and a cam mechanism positioned adjacent to the first recess, wherein the cam mechanism is configured to selectively vary a size of the first recess to couple the structural rod in the first recess.

Another embodiment of the present exemplary system and method provides a method for coupling a connection member to at least one rod includes receiving the orthopedic rod in a first slot of the connection member, and rotating a cam mechanism to frictionally engage the rod in the connection member.

### BRIEF DESCRIPTION OF THE DRAWINGS

The accompanying drawings illustrate various embodiments of the present system and method and are a part of the specification. The illustrated embodiments are merely examples of the present system and method and do not limit the scope thereof.

FIG. 1 is a bottom perspective view of a cam based rod connection system, according to one exemplary embodiment.

FIG. 2 is a top perspective view of the cam based rod connection system of FIG. 1, according to one exemplary embodiment.

FIG. 3 is an exploded perspective view of the cam based rod connection system of FIG. 1, according to one exemplary embodiment.

FIGS. 4A, 4B, and 4C are, respectively, a perspective view and a bottom profile view of a cam screw, and a perspective view of a helical cam screw, according to one exemplary embodiment.

FIGS. 5A and 5B illustrate a top and a bottom perspective view of a housing for the cam based rod connection system of FIG. 1, according to one exemplary embodiment.

FIGS. 6A and 6B illustrate, respectively, a top perspective view and a bottom perspective view of a hybrid cam based rod connection system configured to receive structural rods of different diameters, according to one exemplary embodiment.

FIG. 7 illustrates the steps of joining a plurality of structural rods in a cam based rod connection system, according to one exemplary embodiment.

FIG. 8 is an exploded perspective view of an offset cam based rod connection system, according to one exemplary embodiment.

FIG. 9 illustrates the steps of coupling a cam based rod connection system to a rod, according to one exemplary embodiment.

FIGS. 10A through 10I illustrate both perspective and cross-sectional views of various steps of the coupling method of FIG. 9, according to one exemplary embodiment.

FIGS. 11A and 11B illustrate a perspective and an exploded view, respectively of a cam based rod connection system, according to one exemplary embodiment.

FIGS. 12A through 12H illustrate various perspective and cross-sectional views of the coupling method of FIG. 9, according to one exemplary embodiment.

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings. Throughout the drawings, identical reference numbers designate similar but not necessarily identical elements.

### DETAILED DESCRIPTION

The present specification provides a number of exemplary connection members and methods that can be used for any number of orthopedic rod placement systems. According to the present exemplary system and method, coupling of an orthopedic rod to a housing, a bone screw, and/or another rod is facilitated with the use of a cam screw. Specifically, the present exemplary systems and methods provide for the rotation of a cam screw to frictionally secure one or more orthopedic rod(s) to a desired housing. Due to the rotational engagement of the cam screw, the profile and volume of the present exemplary system are reduced, when compared to traditional systems.

As used in the present specification, and the appended claims, the term “distraction,” when used herein and when used in a medical sense, generally relates to joint surfaces and suggests that the joint surfaces move perpendicular to one another. However when “traction” and/or “distraction” is performed, for example on spinal sections, the spinal sections may move relative to one another through a combination of distraction and gliding, and/or other degrees of freedom.

Further, when used herein, or in the appended claims, the term “rod” is meant to be understood as including any long and relatively thin member, regardless of cross-sectional shape. Specifically, an orthopedic rod, as used herein, may have a substantially circular, oval, or angular cross-section. For ease of explanation only, the present exemplary system and method will be described in the context of an orthopedic rod having a substantially circular cross-section.

Additionally, as used herein, the term “cam” shall be interpreted broadly as including any object having a cross-sectional profile including lobes or outer surface(s) located at differing distances from a central axis, such that when the object is rotated about the central axis, rotational motion is converted to substantially linear motion.

Unless the context requires otherwise, throughout the specification and claims which follow, the word “comprise” and variations thereof, such as, “comprises” and “comprising” are to be construed in an open, inclusive sense, that is as “including, but not limited to.”

Reference in the specification to “one embodiment” or “an embodiment” means that a particular feature, structure, or characteristic described in connection with the embodiment is included in at least one embodiment. The appearance of the phrase “in one embodiment” in various places in the specification are not necessarily all referring to the same embodiment. Furthermore, the particular features, structures, or characteristics may be combined in any suitable manner in one or more embodiments.

In the following description, certain specific details are set forth in order to provide a thorough understanding of various embodiments of the present cam based rod connection system and method. However, one skilled in the relevant art will recognize that the present exemplary system and method may be practiced without one or more of these specific details, or with other methods, components, materials, etc. In other instances, well-known structures associated with pedicle screws have not been shown or described in detail to avoid unnecessarily obscuring descriptions of the embodiments of the systems and methods.

Exemplary Structure

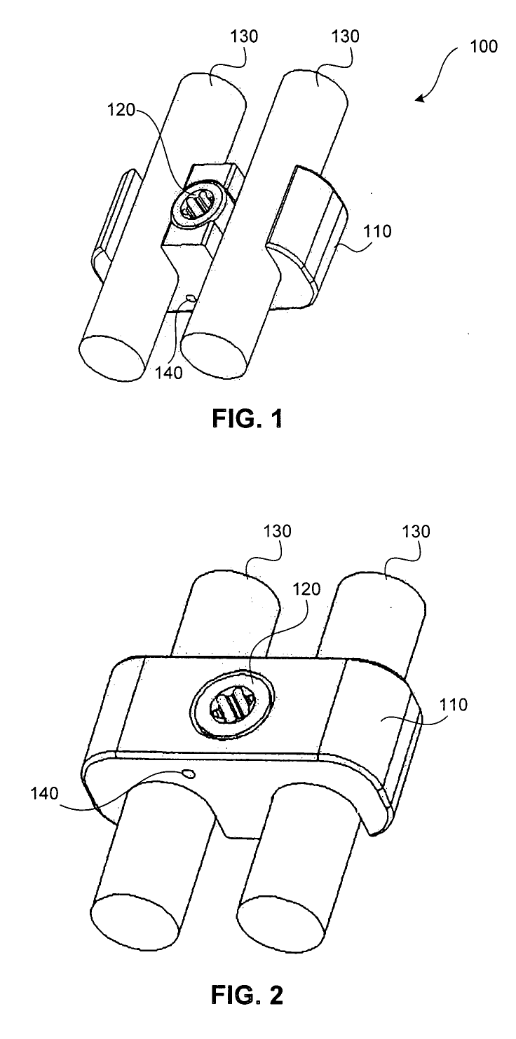

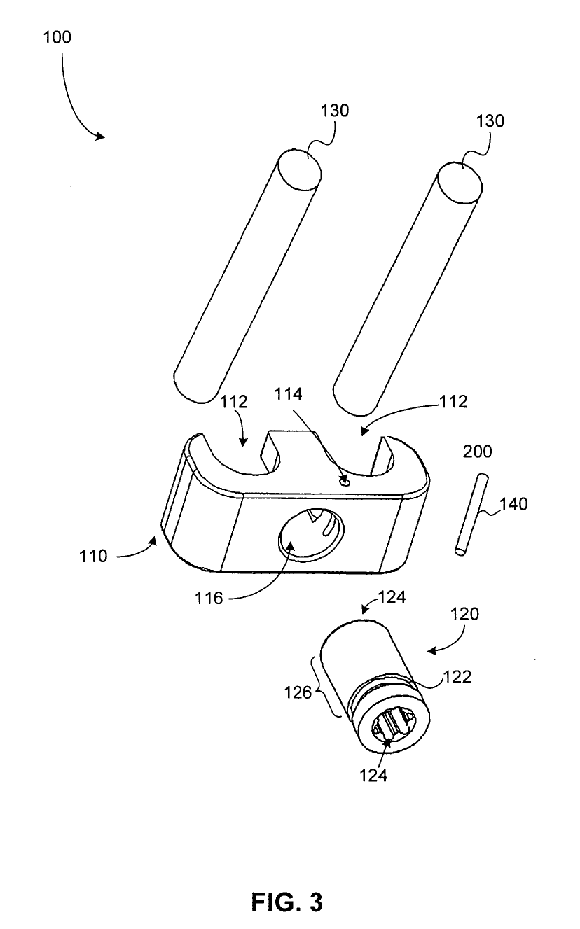

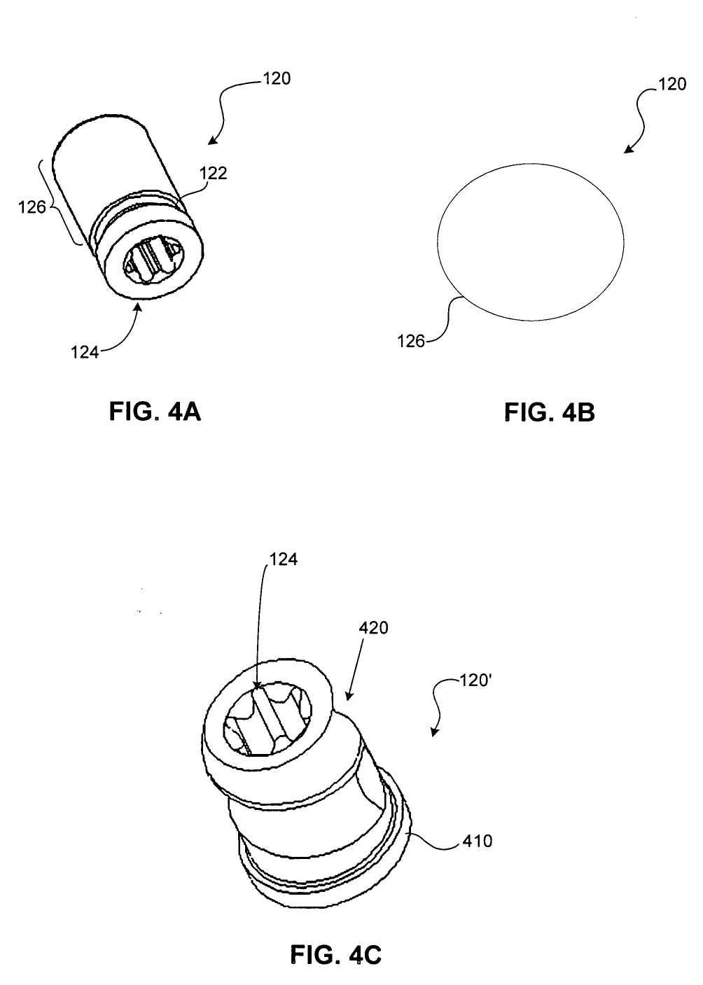

FIGS. 1 and 2 illustrate a bottom perspective view and a top perspective view, respectively, of a cam based rod connection system (100), according to one exemplary embodiment. As illustrated, the exemplary cam based rod connection system (100) includes, but is in no way limited to, a main housing (110) coupling at least one orthopedic rod (130). As shown, the orthopedic rod (130) is disposed between an outer wall of the housing (110) and a cam screw (120) rotatably coupled to the housing. Additionally, according to the exemplary embodiment illustrated in FIGS. 1 and 2, a pin (140) or a set screw is inserted into the housing (110) to rotatably secure the cam screw (120) within the housing (110). Further details of each of the above-mentioned components of the exemplary cam based rod connection system (100) will be provided below, with reference to FIGS. 3 through 4C.

FIG. 3 illustrates an exploded view of the exemplary cam based rod connection system (100), according to one exemplary embodiment. Specifically, the exploded view of FIG. 3 shows added detail of the components of the exemplary cam based rod connection system (100). As shown in FIG. 3, a cam screw (120) is further illustrated, according to one exemplary embodiment. As shown, the exemplary cam screw (120) includes a driving feature (124) formed on each end of the screw. According to one exemplary embodiment, the inclusion of a driving feature on each end of the screw, allowing the cam based rod connection system to be placed either under or over a rod (130) being coupled. Further, the exemplary cam screw (120) includes a pin channel (122) circumferentially formed on the cam screw (120). According to one exemplary embodiment, the pin channel (122) is sized to mate with the pin (140) when inserted in the pin orifice (114). When mated with the pin channel (122), the pin (140) interferes with the cam screw (120), preventing the cam screw (120) from axially translating in or being removed from the cam screw orifice (116). However, no interference prevents the cam screw from merely rotating in the cam screw orifice (116). The cam screw (120) illustrated in FIG. 3 also includes a cam body (126) formed adjacent to the pin channel (122), according to one exemplary embodiment.

FIGS. 4A through 4C further illustrate the components of the cam screw (120), according to various exemplary embodiments. As mentioned above, the cam screw (120) may include any object having a cross-sectional profile including lobes or outer surface(s) located at differing distances from a central axis, such that when the object is rotated about the central axis, rotational motion is converted to substantially linear motion. As shown in FIG. 4A, the exemplary cam screw (120) may be a substantially cylindrical member with a plurality of driving features (124) configured to receive a driving member (not shown). FIG. 4B illustrates an exemplary perimeter profile of the cam body (126). As shown, a plurality of lobes may be formed on opposing surfaces of the cam body (126) such that when the cam screw (120) is rotated within the cam screw orifice (116; FIG. 3), the width of the rod seat (112) is varied.

While the first exemplary embodiment described herein is shown as a cylindrical cam body (126) having a plurality of lobes formed thereon, any number of cam screw configurations may be incorporated by the principles of the present exemplary cam based rod connection system (100), as will be shown in the alternative embodiments discussed below. FIG. 4C illustrates a helical cam screw (120′) that may be used with the present cam based rod connection system (100), according to one exemplary embodiment. As shown in FIG. 4C, the helical cam screw (120′) includes at least one driving feature (124) formed on one end of the helical cam screw. Further, a helical cam groove (420) is formed on the cam body of the helical cam screw (120′). A retention lip (410) or other retention member is formed on the lower portion of the helical cam screw (120′), according to the exemplary illustrated embodiment. As shown, the helical cam screw (120′) is configured to engage a rod (130; FIG. 3) at the upper surface of the helical cam groove (420). When the helical cam screw (120′) is subsequently rotated, the engaged rod (130; FIG. 3) is forced down the helical cam groove (420). This and other cam screws will be described in detail, in connection with various uses below, with reference to the alternative embodiments.

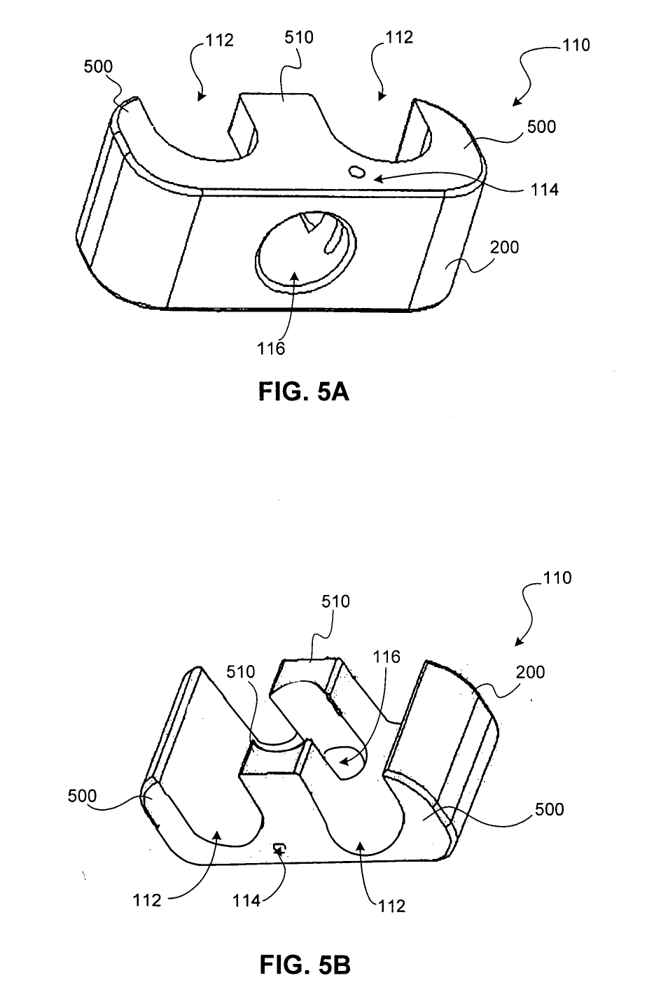

Returning again to FIG. 3, the housing (110) of the exemplary cam based rod connection system (100) includes a main body (200) with a plurality of recesses, or rod seats (112) defined therein. Specifically, as shown in FIGS. 5A and 5B, the main body (200) may include a plurality of arm protrusions (500) formed on the periphery of the main body. Additionally, a center member (510) may be formed between the two arm protrusions (500), defining the plurality of rod seats (112). Further, a cam screw orifice (116) is defined in the main body (200) of the housing (110). According to the exemplary embodiments illustrated in FIGS. 5A and 5B, the cam screw orifice (116) traverses the center member (510), has an axis substantially perpendicular to the axis of the rod seats (112), and is sized to rotatably receive the cam screw (120). Further, the cam screw orifice (116) may be configured to receive the cam screw (120) and allow it to freely float between inserted rods (130), thereby allowing for an equal pressure on each rod inserted into the housing (110). A pin orifice (114) is also formed in the body (200) of the housing (110). As shown, the pin orifice (114) is formed with an axis substantially perpendicular to the cam screw orifice (116). The pin orifice (114) traverses the cam screw orifice (116) such that insertion of the pin (140) reduces the cross-sectional area of the cam screw orifice to retain the cam screw (120) in the cam screw orifice.

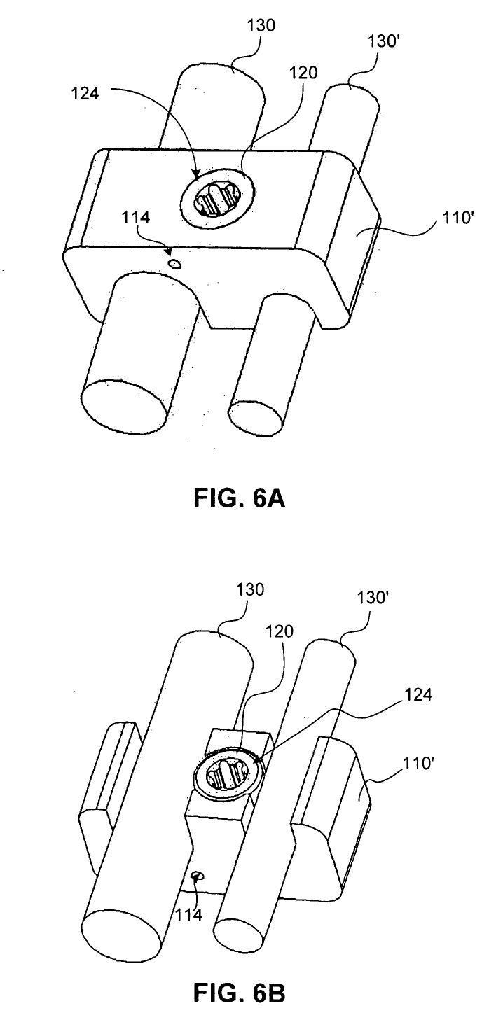

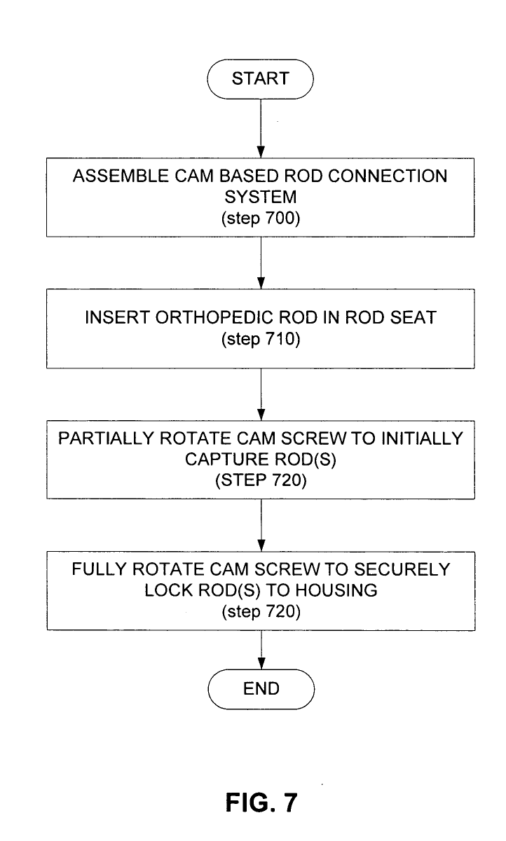

While the exemplary rods (130; FIG. 3) are illustrated as having the same outer diameter, rods of varying diameters may also be coupled with the present exemplary cam based rod connection system (100; FIG. 3), according to one exemplary embodiment. As illustrated in FIGS. 6A and 6B, a hybrid housing (110′) may be used to couple a rod (130) with a reduced rod (130′) having a smaller outer diameter. According to this exemplary embodiment, the rod seats (112; FIG. 3) may be formed with different sizes, to accommodate rods with differing outer diameters (130, 130′). Alternatively, the lobes of the cam screw (120) may be of different sizes to selectively modify the size of the rod seats (112) when actuated. According to one exemplary embodiment, the ability to receive rods of differing outer diameter will allow the cam based rod connection system (100) to be used at an interface between sets of vertebrae. Specifically, the lumbar vertebrae are larger than the thoracic vertebrae, which are larger than the cervical vertebrae. Consequently, varying forces, corresponding to the vertebrae size and function may be imparted by rods having varying outer diameters. In this instance, the cam based rod connection system (100) may be used to couple the various rods. Additionally, providing a rod seat (112; FIG. 3) for each coupled rod allows the cam based rod connection system to couple rods that are in an offset orientation. This is particularly advantageous in providing a lateral offset to assist in crossing the cervico-thoracic junction. Similarly, the present cam based rod connection system (100) may be used simply to extend an existing construct with substantially similar outer rod diameters. Details of the operation of the present exemplary cam based rod connection system (100) will be provided below, with specific reference to FIG. 7.

Exemplary Method and Operation

FIG. 7 illustrates an exemplary method for coupling at least one orthopedic rod using the above-mentioned exemplary cam based rod connection system (100), according to one exemplary embodiment. As illustrated in FIG. 7, the present exemplary method begins by first assembling the cam based rod connection system (step 700). Once the system is assembled (step 700), one or more orthopedic rods can be inserted in the rod seat portion of the cam based rod connection system (step 710). With the desired rod(s) inserted, the cam screw can be partially rotated to initially capture the rod (step 720), followed by a full rotation to securely lock the rod(s) to the housing (step 730). Further details of each step of the exemplary rod coupling method will be provided below.

First, the cam based rod connection system is assembled (step 700). As described in FIGS. 1-3, assembly of the cam based rod connection system (100) includes inserting the cam screw (120) into the cam screw orifice (116). As mentioned, the cam screw orifice (116) is sized to slideably receive the cam screw (120). Once the cam screw (120) is correctly positioned in the cam screw orifice, assembly continues with insertion of the pin (140) into the pin orifice (114). According to this exemplary embodiment, the pin (140) forms an obstruction in the cam screw orifice (116) that corresponds with the pin channel (122), allowing the cam screw (120) to rotate within the cam screw orifice (116), without allowing the cam screw to be removed from the housing (110).

With the cam based rod connection system (100) assembled, the desired orthopedic rods may be inserted into the rod seat(s) (step 710; FIG. 7). According to one exemplary embodiment, when in its initial assembled position, the cam screw (120) is oriented such that the smallest diameter section is engaged with the rod seat (112), thereby maximizing the width of the rod seats for reception of the rod(s) (130). The present exemplary cam based rod connection system (100) may be placed over or under a plurality of rods (130) for engagement. The present configuration provides a sufficiently low profile to allow engagement from either orientation. Additionally, the formation of a driving feature (124) on each side of the cam screw (120) enables engagement regardless of the housing orientation.

With the desired rod(s) (130) inserted in the rod seat(s) (112), the cam screw (120) can be partially rotated to initially capture the desired rod(s). According to one exemplary embodiment, partial rotation of the cam screw (120) causes the lobes of the cam screw to engage the outer surface of the rod(s) and impart an initial frictional force thereon. The initial frictional force causes the rod(s) (130) to remain in the rod seat(s) (112), while allowing a surgeon to overcome the friction to slideably position the rod(s) (130).

When correctly positioned, the cam screw (120) can be fully rotated to securely lock the rod(s) to the housing (step 720). Full rotation of the cam screw (120) will cause the highest surface of the lobed cam screw (120) to contact the rod(s) (130), thereby imparting the greatest frictional force thereon.

Alternative Embodiments

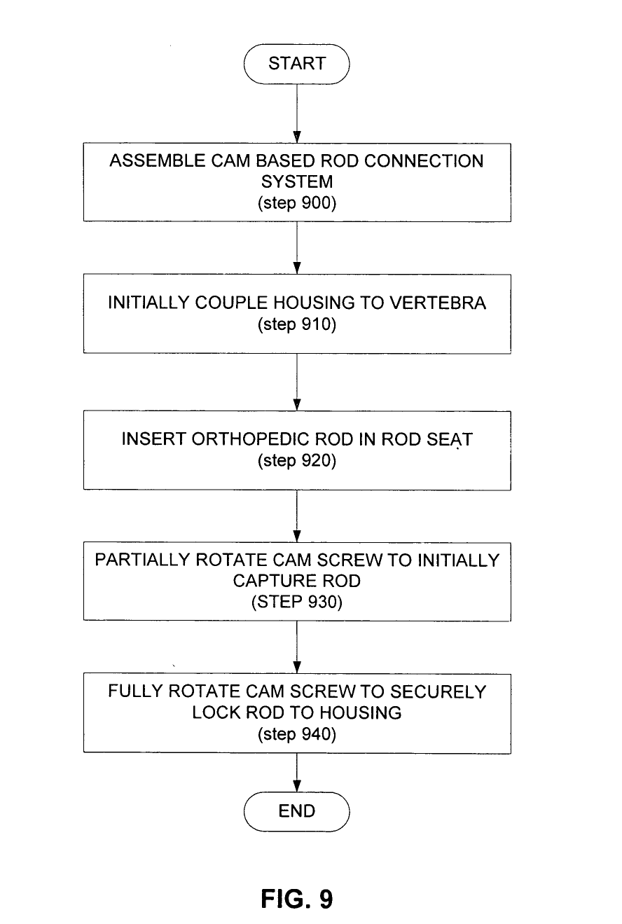

As mentioned previously, slightly varying the housing (110) and/or the cam screw (120) allows the present exemplary cam based rod connection system (100) to securely couple a rod (130) to various structures. FIG. 9 illustrates an exploded view of an offset cam based rod connection system (800), according to one exemplary embodiment. As shown in FIG. 9, an offset cam based rod connection system (800) may include an offset cam screw (820), a rod (130), an offset cam housing (810), and a bone screw (850). The exemplary offset cam based rod connection system (800) may provide a low profile, few component system for connecting an orthopedic rod (130) to a poly-axial thoracic or other bone screw (850). The ability to securely couple a rod (130) to an offset bone screw (850) can be advantageous for correcting scoliosis deformities or providing a lateral offset option for spinal procedures. Details of each exemplary component of the offset cam based rod connection system (800) will be provided below.

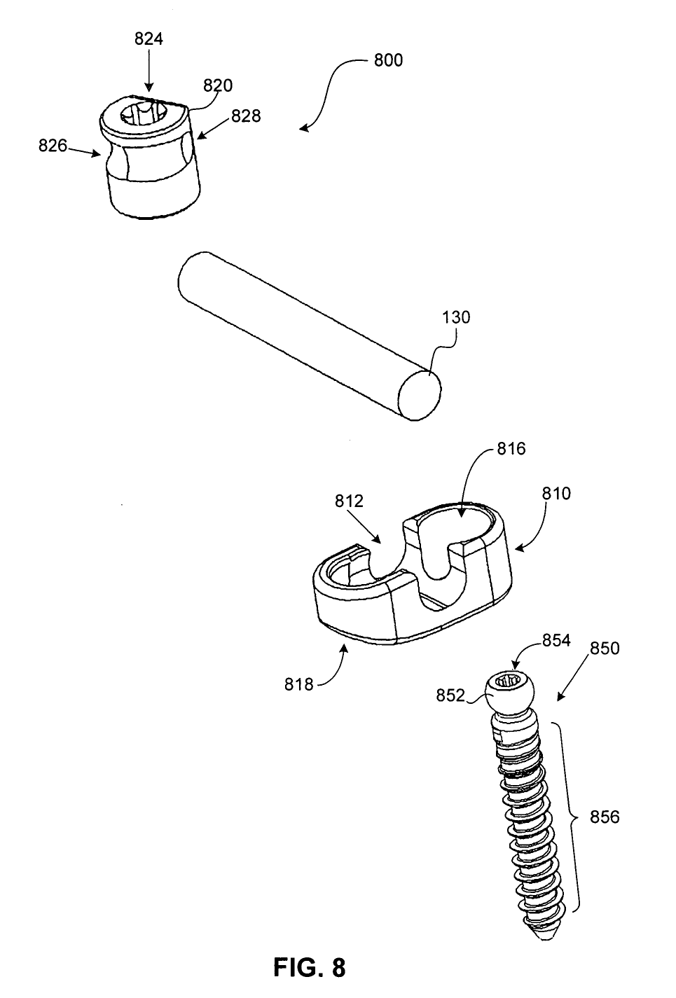

As shown in FIG. 8, the exemplary offset cam screw (820) includes a driving feature (824) formed on a top feature. According to one exemplary embodiment, the driving feature (824) may be configured to couple a rotational driving member (not shown). Additionally, the exemplary offset cam screw (820) has a varying outer profile including a cammed groove (826) on a first circumferential portion of the cam screw, and a cut-out entry surface (828) formed on a second circumferential portion of the cam screw.

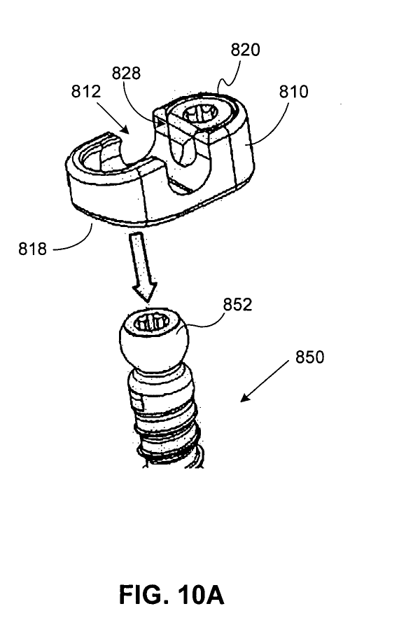

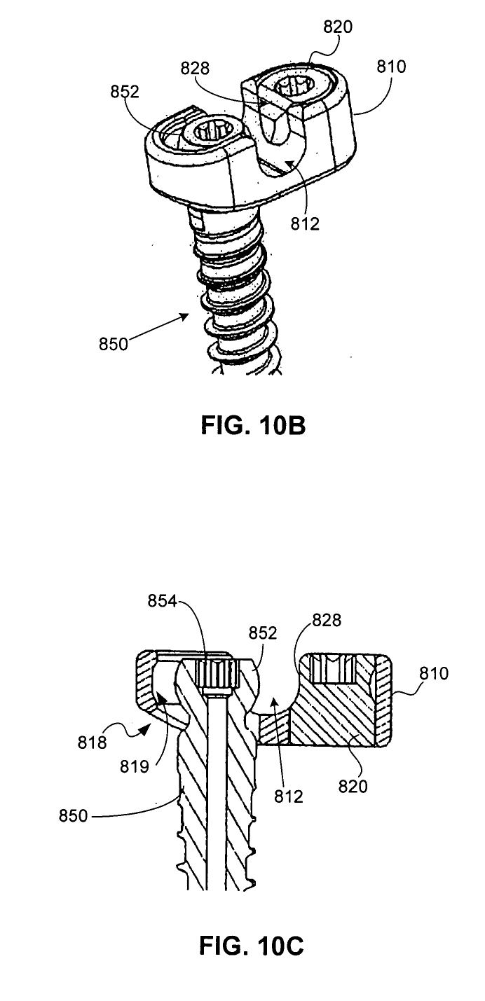

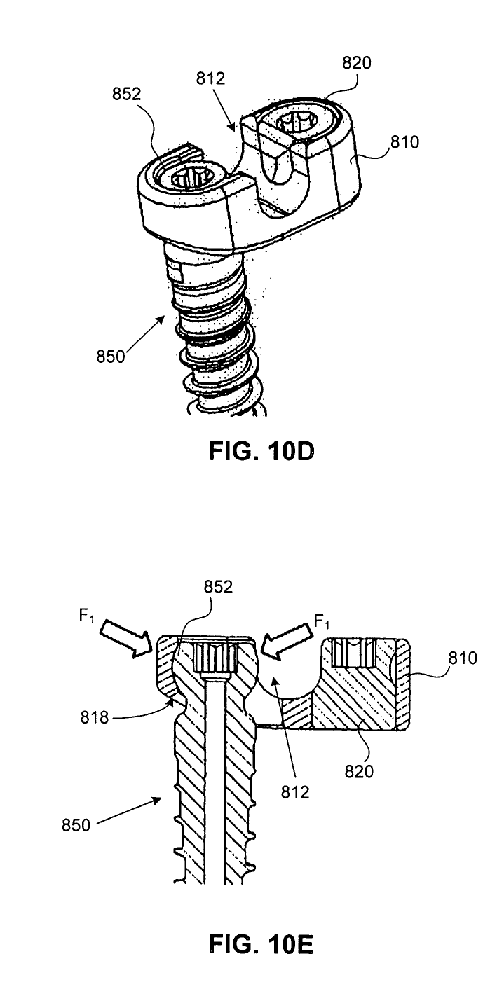

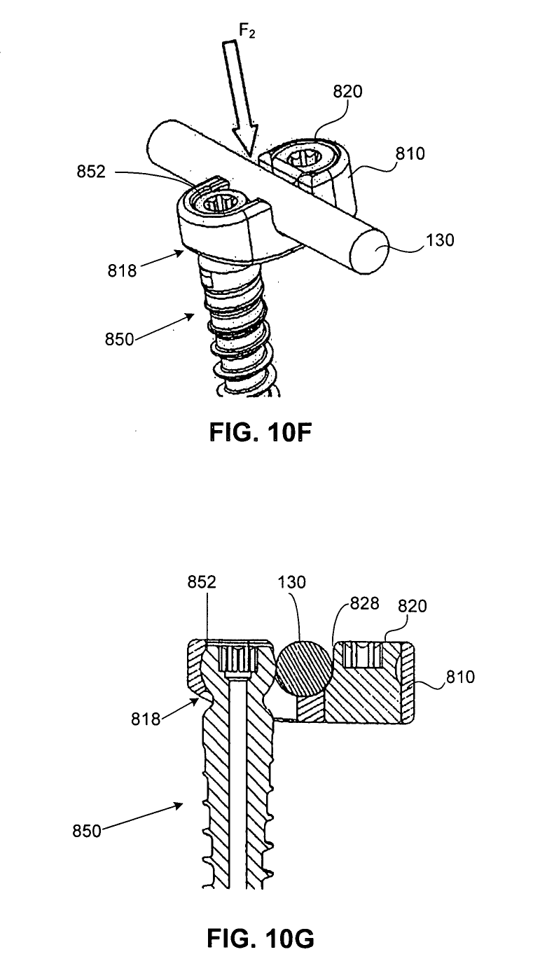

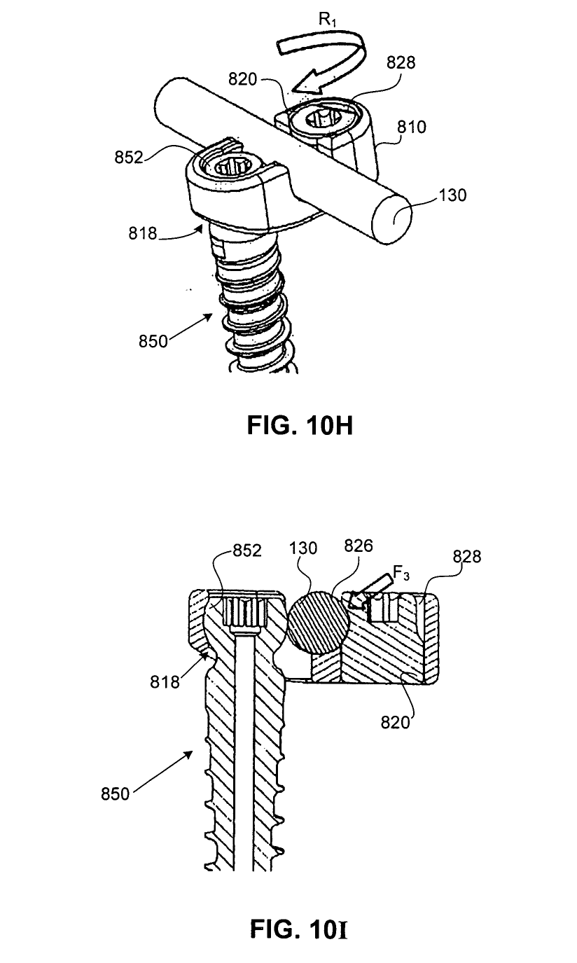

Similar to the housing illustrated above, the offset cam housing (810) illustrated in FIG. 8 includes a cam screw orifice (816) configured to rotatably receive the offset cam screw (820). Additionally, the exemplary offset cam housing (810) illustrated in FIG. 8 includes a rod seat (812) portion configured to receive a rod (130) adjacent to the cam screw orifice (816). Further, as illustrated in FIG. 8, a bone screw seat (818) is formed in the exemplary offset cam housing (810) adjacent to the rod seat (812). According to one exemplary embodiment, illustrated in FIG. 10C, the bone screw seat (818) includes a cutout configured to securely receive and retain the head portion (852) of a bone screw (850), as will be described in further detail below.

Another element of the exemplary offset cam based rod connection system (800) illustrated in FIG. 8 is the bone screw (850). As shown, the bone screw includes a head portion (852) including a head driving feature (854) and an elongated thread portion (856). The driving feature (854) of the present exemplary cam based rod connection system (800) permits the screw to be inserted into a pedicle bone and/or other bone. According to one exemplary embodiment, the pedicle bone is a part of a vertebra that connects the lamina with a vertebral body. Additionally, according to the present exemplary embodiment, the driving feature (854) can be used to adjust the bone screw (850) prior to or after the exemplary offset cam housing (810) is coupled to the bone screw. In the illustrated embodiment, the head portion (852) of the bone screw (850) is coupled to the threaded portion (856) and includes a generally spherical surface with a truncated or flat top surface.

In one exemplary embodiment, the bone screw (850) is cannulated, which means a channel (not shown) extends axially through the bone screw. The channel (not shown) allows the bone screw (850) to be maneuvered over and receive a Kirschner wire, commonly referred to as a K-wire. The K-wire is typically pre-positioned using imaging techniques, for example, fluoroscopy imaging, and then used to provide precise placement of the bone screw (850). While the bone screw (850) illustrated in FIG. 8 includes a number of components, numerous variations may be made including, but in no way limited to, varying the type of driving feature (854), varying the head shape, varying materials, varying dimensions, and the like.

FIG. 9 illustrates an exemplary method for using the offset cam based rod connection system (800) of FIG. 8. Similar to the exemplary method illustrated in FIG. 7, the method for using the offset cam based rod connection system (800) includes first assembling the cam based rod connection system (step 900). With the connection system assembled, the housing may be initially coupled to the head portion of the bone screw (step 910), followed by inserting the orthopedic rod into the rod seat (step 920). Once the orthopedic rod is positioned in its seat, the cam screw can be partially rotated to initially capture the rod and screw head (step 930). Additionally, the cam screw may be further rotated to securely lock the rod and screw head to the housing (step 940). Details of the present exemplary coupling method will be provided below with reference to FIGS. 10A through 10I.

As mentioned, the first step in the present exemplary method is assembling the cam based rod connection system (step 900). As shown in FIG. 10A, an assembled cam based rod connection system (800) includes inserting the offset cam screw (820) into the cam screw orifice (816). The exemplary offset cam screw (820) may be secured in the cam screw orifice (816) by any number of protrusions, pins, threads, and the like. Once secured in the cam screw orifice (816), the offset cam screw (820) is oriented such that the cut out entry surface (828) is oriented toward the rod seat (812) portion of the exemplary offset cam housing (810). Orienting the cut out entry surface (828) toward the rod seat (812) allows the rod seat (812) to be unobstructed.

Once assembled, the housing may be initially coupled to the head of the bone screw (step 910; FIG. 9) by inserting the head portion (852) of the bone screw (850) into the bone screw seat (818), as shown in FIGS. 10B through 10E. As shown, the head portion (852) of the bone screw (850) can be inserted into the bone screw seat (818) by passing through a lateralized thru hole (819) formed in the base of the exemplary offset cam housing (810). The screw head (852) is further inserted into the bone screw seat (818) by forcing the screw head medial to the rod seat (812). According to one exemplary embodiment, the screw head may be forced (F₁) medial using an instrument or manually, snapping the screw head (852) into the spherical rod seat (812), thereby retaining the screw head (852) while providing poly-axial movement.

With the housing coupled to the head of the bone screw (step 910), the orthopedic rod may be inserted into the rod seat (step 920). As illustrated in FIGS. 10F and 10G, insertion of the rod (130) into the rod seat (812) is facilitated by the position of the offset cam screw (820). Specifically, orienting the cut-out entry surface (828) of the offset cam screw (820) toward the rod seat (812) maximizes the width of the rod seat (812), allowing the rod (130) to be forced (F₂) into the rod seat (812).

When the rod (130) is inserted into the rod seat (812), the offset cam screw (820) may be partially rotated to initially capture the rod and screw head within the offset cam housing (step 930). As illustrated in FIGS. 10H and 10I, when the offset cam screw (820) is partially rotated (R₁), the cammed groove (826) of the offset cam screw engages the rod (130), forcing the rod against the head portion (852) of the bone screw (850). According to this exemplary embodiment, the friction imparted is sufficient to retain the rod (130) within the housing (810), while allowing the rod to slide within the body. This enables a surgeon to provisionally place the rod and other orthopedic structures. When the desired structures are appropriately placed, the offset cam screw (820) may be fully rotated (R₁) to securely lock the rod (130) and the screw head (852) to the housing (step 940). As shown in FIG. 10I, the full rotation of the offset cam screw (820) forces the rod (130) against the screw head (852) and into the bottom of the rod seat (812) to securely lock the assembly.

While the exemplary embodiment illustrated in FIGS. 10A through 10I illustrate an exemplary cam based rod connection system (800) that incorporates a bone screw (850) to couple the system to a spinal location, other connection means may be used including, but in no way limited to, a laminar hook. Specifically, laminar hooks are used to couple a lamina or transverse process to maintain a rod in place. Laminar hooks are particularly useful in the correction of scoliosis or other deformation correction.

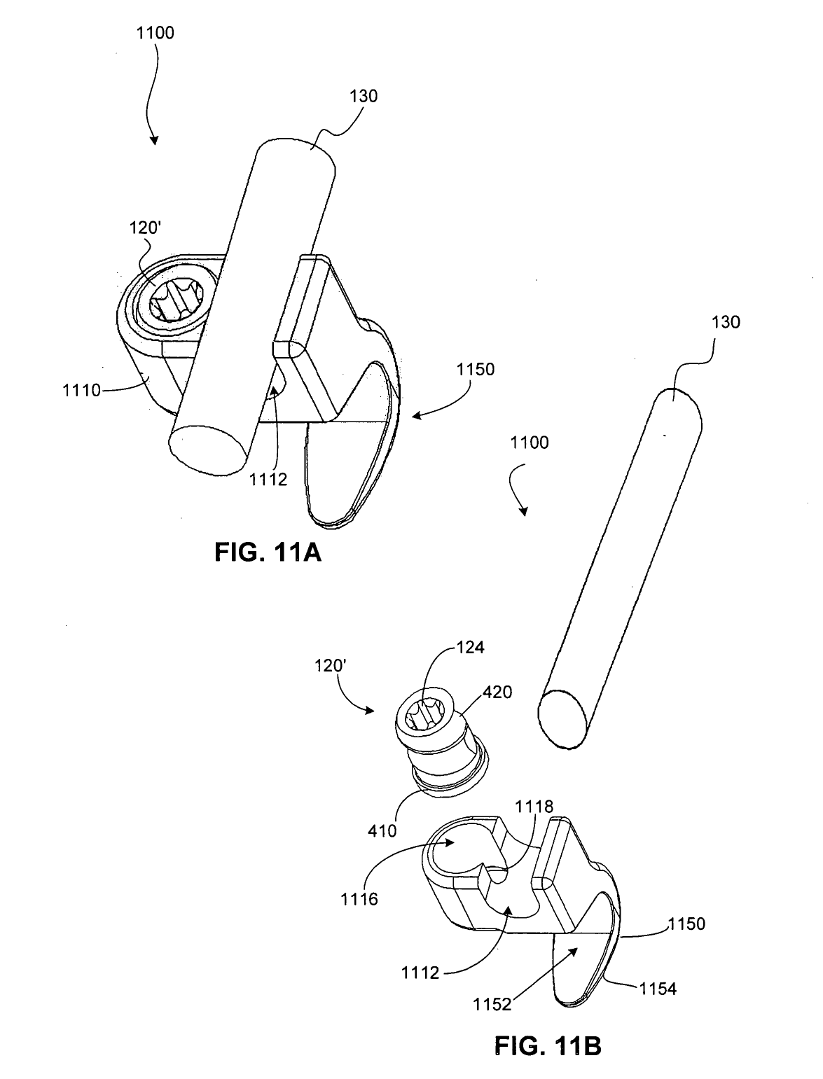

FIGS. 11A and 11B illustrate an assembled perspective view and an exploded perspective view, respectively, of an exemplary cam based rod connection system (1100) that incorporates a laminar hook (1150). Specifically, as shown, the exemplary cam based rod connection system (1100) including a laminar hook (1150) includes a housing (1110), having a cam screw orifice (1116) formed therein. As shown in FIG. 11B, the exemplary cam screw orifice (1116) includes a cam screw retention seat (1118) formed in a lower portion thereof. Additionally, as shown, a rod seat (1112) is disposed adjacent to the cam screw orifice (1116) and is sized for the reception of a rod (130).

In contrast to the exemplary cam based rod reception systems described above, the exemplary embodiment illustrated in FIGS. 11A and 11B include a laminar hook (1150) protruding from a lower portion of the housing (1110). As shown, the laminar hook (1150) includes a hook protrusion (1154) extending in a curvilinear fashion from the lower portion of the housing (1110), defining a hook cavity (1152).

Further, as illustrated in FIG. 11B, the exemplary cam based rod connection system (1100) incorporates a helical cam screw (120′). While a helical cam screw (120′) is illustrated in FIG. 11B, any of the above-mentioned cam screws may also be incorporated into the present exemplary laminar hook embodiment. As mentioned previously, the exemplary helical cam screw (120′) may include at least one driving feature (124) formed on one end of the helical cam screw. Further, a helical cam groove (420) is formed on the cam body of the helical cam screw (120′). A retention lip (410) or other retention member is formed on the lower portion of the helical cam screw (120′), according to the exemplary illustrated embodiment. As shown, the helical cam screw (120′) is configured to engage a rod (130; FIG. 3) at the upper surface of the helical cam groove (420). When the helical cam screw (120′) is subsequently rotated, the engaged rod (130; FIG. 3) is forced down the helical cam groove (420).

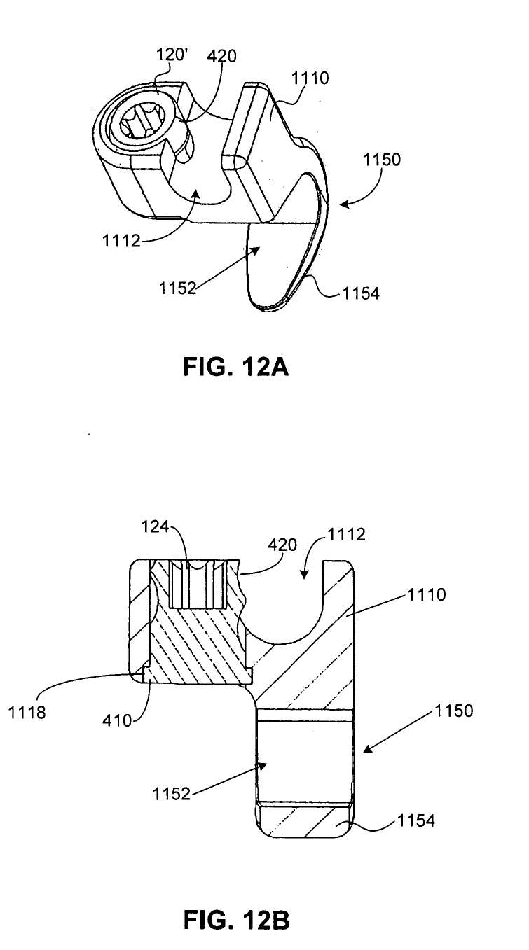

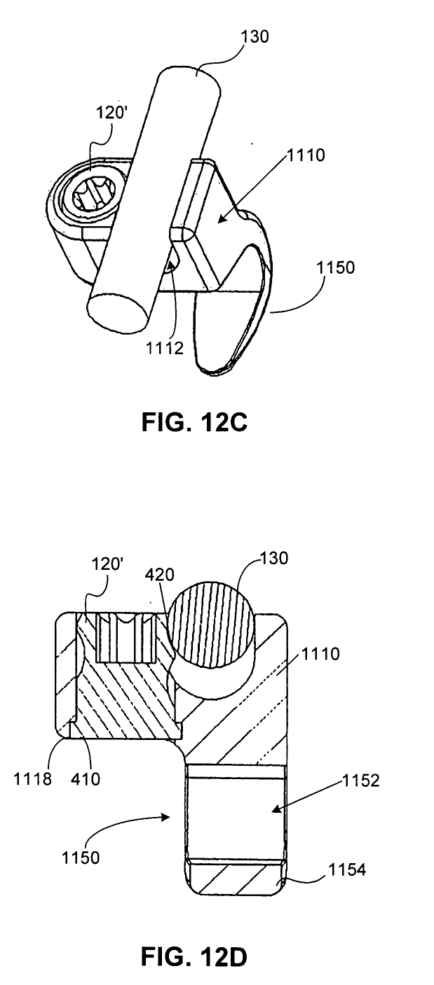

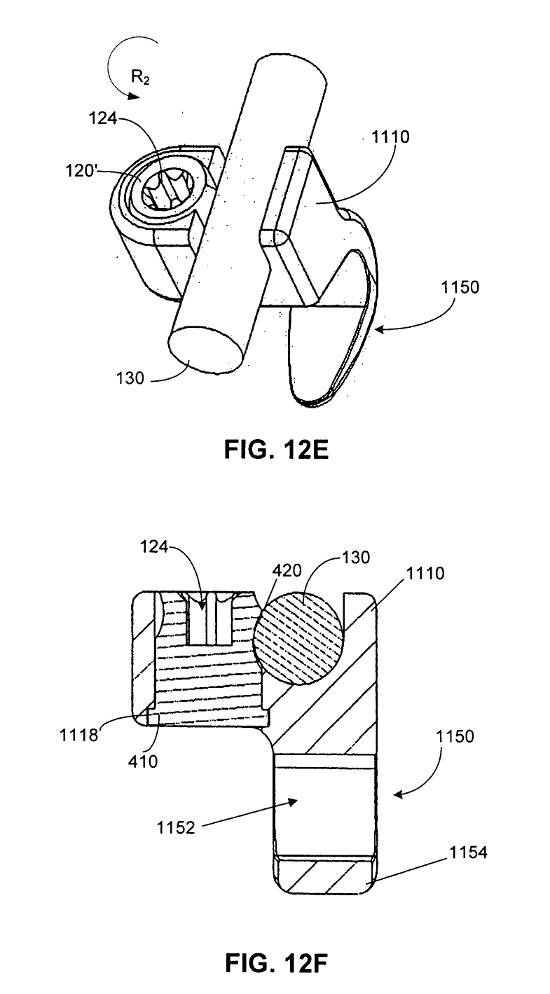

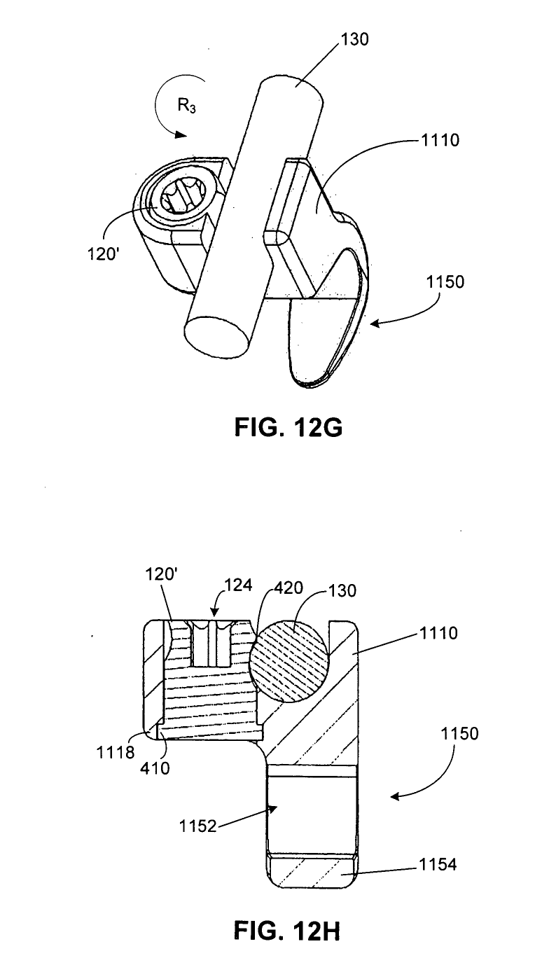

According to one exemplary embodiment, the method of FIG. 9 may be used to secure an orthopedic rod (130) with the exemplary cam based rod connection system (1100) including a laminar hook (1150), as illustrated in FIGS. 12A through 12H. According to one exemplary embodiment, the first steps in securing a desired orthopedic rod (130) with the exemplary cam based rod connection system (1100) including a laminar hook (1150) include assembling the cam based rod connection system (step 900). As shown in FIGS. 12A and 12B, assembly of the cam based rod connection system (1100) includes inserting the helical cam screw (120′) in the cam screw orifice (1116). As shown in FIG. 12B, when the exemplary helical cam screw (120′) is inserted into the cam screw orifice (1116), the retention lip (410) engages the cam screw retention seat (1118), thereby providing an anchor for the helical cam screw (120′) to impart a downward force on a subsequently coupled orthopedic rod (130).

Once assembled, the housing may be initially coupled to a desired orthopedic location. Rather than coupling the housing to a bone screw, as suggested in FIG. 9, the present exemplary cam based rod connection system (1100) including a laminar hook (1150) is configured to be coupled to a lamina, a transverse process, or another posterior element of a desired vertebra. When coupled, the desired lamina or transverse process is securely disposed in the hook cavity (1152).

Once secured, an orthopedic rod (130) can be inserted in the rod seat (step 920; FIG. 9). As illustrated in FIGS. 12C and 12D, the insertion of the rod (130) into the rod seat includes persuading a rod (130) into contact with the helical cam screw (120′). As shown in FIG. 12D, the rod (130) engages the upper portion of the helical cam groove (420).

Once the rod is received (130), the helical cam screw (120′) can be partially rotated to provisionally capture the rod (step 930; FIG. 9). As illustrated in FIGS. 12E and 12F, the rotation (R₂) of the helical cam screw (120′) causes the rod (130) to be drawn into the rod seat (1112). Specifically, as the helical cam screw (120′) is rotated, the rod (130) is drawn downward in the helical cam groove (420). According to this exemplary embodiment, the partial rotation of the helical cam screw (120′) caused the rod to still be free to slide/rotate relative to the housing (1110), thereby providing for spinal curve correction via de-rotation and compression/distraction techniques.

Once the rod is correctly placed, the helical cam screw (120′) may be fully rotated to securely lock the rod (130) relative to the housing (step 940; FIG. 9). As illustrated in FIGS. 12G and 12H, the full rotation (R₃) of the helical cam screw (120′) rigidly secures the rod (130) against the housing (1110). When in its final locked position, the helical cam groove (410) exerts a downward force on the rod (130), thereby creating a frictional retaining effect. The downward force exerted by the helical cam groove (410) is resisted by the interference between the retention lip (410) and the cam screw retention seat (1118).

In conclusion, the present exemplary cam based rod connection systems and methods provide a number of exemplary connection configurations and methods that can be used for coupling a plurality of orthopedic rods together or coupling one or more orthopedic rods to an anchoring device. Specifically, the present exemplary systems and methods leverage the rotational motion of a cam screw to impart a compressive force on a desired rod, thereby reducing the coupler profile when compared to traditional coupling devices. Additionally, the use of a cam screw to both provisionally secure the rod as well as ultimately lock the rod reduces the component count when compared to traditional systems that often use set-screws and other securing devices. Further, the present exemplary systems and methods provide for an offset to correct scoliosis deformities or to provide a lateral offset option for lumbar spine procedures.

It will be understood that various modifications may be made without departing from the spirit and scope of the present exemplary systems and methods. For example, while the exemplary implementations have been described and shown using screws and/or hooks to anchor into bony structures, the scope of the present exemplary system and methods is not so limited. Any means of anchoring can be used, such as a cam, screw, staple, nail, pin, or hook.

The preceding description has been presented only to illustrate and describe embodiments of invention. It is not intended to be exhaustive or to limit the invention to any precise form disclosed. Many modifications and variations are possible in light of the above teaching. It is intended that the scope of the invention be defined by the following claims.

What is claimed is:

1. A coupler for coupling an orthopedic rod, comprising:
a coupler body defining a first recess sized to receive said orthopedic rod; and
a cam mechanism positioned adjacent to said first recess, wherein said cam mechanism is configured to selectively vary a size of said first recess to couple said orthopedic rod in said first recess.

2. The coupler of claim 1, wherein said cam mechanism is rotatably coupled to said coupler body.

3. The coupler of claim 1, wherein said cam mechanism comprises a lobed cam screw.

4. The coupler of claim 1, wherein said cam mechanism comprises a helical cam screw.

5. The coupler of claim 1, further comprising a second recess defined by said coupler body;
wherein said first recess is sized to receive a first orthopedic rod;
wherein said second recess is sized to receive a second orthopedic rod; and
wherein said cam mechanism is disposed in said coupler body between said first recess and said second recess, said cam mechanism being configured to simultaneously reduce a size of said first and said second recess upon rotation of said cam mechanism.

6. The coupler of claim 5, wherein said first recess is a different size than said second recess.

7. The coupler of claim 5, further comprising a retaining member configured to maintain said cam mechanism in said coupler body.

8. The coupler of claim 7, wherein said retaining member comprises one of a pin or a set screw.

9. The coupler of claim 5, wherein said cam mechanism further comprises a driving feature formed in a first end of said cam mechanism.

10. The coupler of claim 9, wherein said cam mechanism further comprises a second driving feature formed in a second end of said cam mechanism.

11. The coupler of claim 1, further comprising an orifice including a recess defined by said coupler body;
wherein said orifice is configured to receive a screw head of a screw; and
wherein said cam mechanism is positioned to urge an orthopedic rod disposed in said first recess against said screw head to seat said screw head in said recess.

12. The coupler of claim 11, wherein said cam mechanism is rotatable to a first position to retain said orthopedic rod between said cam mechanism and said screw head.

13. The coupler of claim 12, wherein said cam mechanism is rotatable to a second position to fixedly retain said orthopedic rod between said cam mechanism and said screw head.

14. The coupler of claim 1, further comprising a hook member coupled to said coupler body, wherein said hook member is configured to engage a posterior element of a vertebra.

15. The coupler of claim 14, wherein said cam screw comprises a helical cam screw.

16. A coupler for coupling a first orthopedic rod to a second orthopedic rod, comprising:
a coupler body including a first slot and a second slot, said first slot configured to receive said first orthopedic rod and said second slot being configured to receive said second orthopedic rod; and
a cam mechanism positioned between said first slot and said second slot;
wherein said cam mechanism is configured to, when rotated, simultaneously reduce a size of said first slot and said second slot to retain said first orthopedic rod and said second orthopedic rod.

17. The coupler of claim 16, wherein said cam mechanism comprises:
a first recess in a first end of said cam mechanism, said first recess being configured to receive a driving tool; and
a second recess in a second end of said cam mechanism, said second recess being configured to receive said driving tool.

18. An assembly comprising:
a coupler having a first opening to receive a screw head of a screw, a slot positioned adjacent to said first opening, a recess adjacent to the slot; and
a cam mechanism positioned in the recess and rotatable to urge a spinal rod located in the slot against the screw head.

19. The assembly of claim 18, wherein said coupler further comprises a wall extending from said first opening, said wall being configured to abut said screw head when said cam mechanism is positioned to urge said spinal rod against said screw head.

20. A coupler for coupling an orthopedic rod, comprising:
a coupler body defining a first recess sized to receive said orthopedic rod;
a cam mechanism positioned adjacent to said first recess, wherein said cam mechanism is configured to selectively vary a size of said first recess to couple said orthopedic rod in said first recess; and
a hook member coupled to said coupler body, wherein said hook member is configured to engage a posterior element of a vertebra.

21. The coupler of claim 20, wherein said cam screw comprises a helical cam screw.

22. A method for coupling an orthopedic rod to a housing comprising:
receiving said orthopedic rod in a first slot of said housing; and
rotating a cam mechanism to frictionally engage said rod in said housing.

23. The method of claim 22, wherein said rotating said cam mechanism further comprises forcing said rod against a head of a screw to seat said head of a screw in said housing.

24. The method of claim 22, further comprising receiving a second orthopedic rod in a second slot of said housing, wherein rotating said cam mechanism reduces a size of said first slot and said second slot, frictionally engaging both said first orthopedic rod and said second orthopedic rod in said housing.
